(19) United States
(12) Patent Application Publication
(10) Pub. No.: US 2012/0203882 A1
(43) Pub. Date: Aug. 9, 2012

(54) MANAGEMENT APPARATUS AND MANAGEMENT METHOD

(75) Inventor: Toshio Ohashi, Chigasaki-shi (JP)

(73) Assignee: CANON KABUSHIKI KAISHA, Tokyo (JP)

(21) Appl. No.: 13/363,170

(22) Filed: Jan. 31, 2012

(30) Foreign Application Priority Data
Feb. 3, 2011 (JP) 2011-021699

(51) Int. Cl. G06F 15/173

(52) U.S. Cl. 709/223

(57) ABSTRACT

A management apparatus of the present invention includes a first selection unit configured to display a map indicating a location of a plurality of network devices on a network and select a network device as a restart target via the map, a second selection unit configured to display a list including device information of the plurality of network devices and select a network device as a restart target via the list, and a request unit configured to request the network device selected by the first or the second selection unit to restart at a desired time.

### BACKGROUND OF THE INVENTION

1. Field of the Invention

The present invention relates to a management technique useful for managing a network device.

2. Description of the Related Art

Some conventional management apparatuses that manage network devices issue a restart command to a network device after determining whether the network device can be restarted. Japanese Patent Application Laid-Open No. 2003-316465 discusses such an apparatus.

Although it is useful to know the location of the device while considering a restart reason and management status, the conventional management apparatuses are unable to confirm the location of the device to appropriately restart the device.

### SUMMARY OF THE INVENTION

According to an aspect of the present invention, a management apparatus managing device information of a network device includes an acquisition unit configured to acquire device information from a plurality of network devices on a network, a first selection unit configured to display a map indicating locations of the plurality of network devices on the network and accept a selection of a network device as a restart target via the map, a second selection unit configured to accept a selection of the network device as a restart target via a list of the plurality of network devices displayed by using the acquired device information, an input unit configured to input a time that a request for restart of the network device selected by the first or the second selection unit is to be transmitted, and a request unit configured to request the network device selected by the first or the second selection unit at the time input via the input unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a hardware configuration of a network system.

FIGS. 2A and 2B illustrate a software configuration of the network system.

FIGS. 3A, 3B, and 3C illustrate a database configuration.

FIG. 4 is a flowchart illustrating operations of an application server according to a first exemplary embodiment of the present invention.

FIG. 5 illustrates an example of a user interface (UI) screen of a map according to the first exemplary embodiment.

FIG. 6 illustrates an example of a user interface (UI) screen of a list according to the first exemplary embodiment.

FIG. 7 illustrates an example of a user interface (UI) screen for confirmation according to a second exemplary embodiment of the present invention.

FIG. 8 is a flowchart illustrating operations of the application server according to the second exemplary embodiment.

FIG. 9 illustrates an example of the UI screen according to the second exemplary embodiment.

FIG. 10 is a flowchart illustrating operations of the application server according to a third exemplary embodiment of the present invention.

FIG. 11 illustrates an example of a UI screen (1) according to the third exemplary embodiment.

FIG. 12 illustrates an example of a UI screen (2) according to the third exemplary embodiment.

FIG. 13 is a flowchart illustrating operations of the application server according to a fourth exemplary embodiment of the present invention.

FIG. 14 illustrates an example of the UI screen according to the fourth exemplary embodiment.

### DESCRIPTION OF THE EMBODIMENTS

Various exemplary embodiments, features, and aspects of the invention will be described in detail below with reference to the drawings.

In the description below, an application server will be described as an exemplary embodiment of a management apparatus according to the present invention. Further, in a first exemplary embodiment of the present invention, a multifunction peripheral (MFP) will be described as an example of a network device. The network device can also be a network peripheral device such as a printer or a facsimile (FAX) machine.

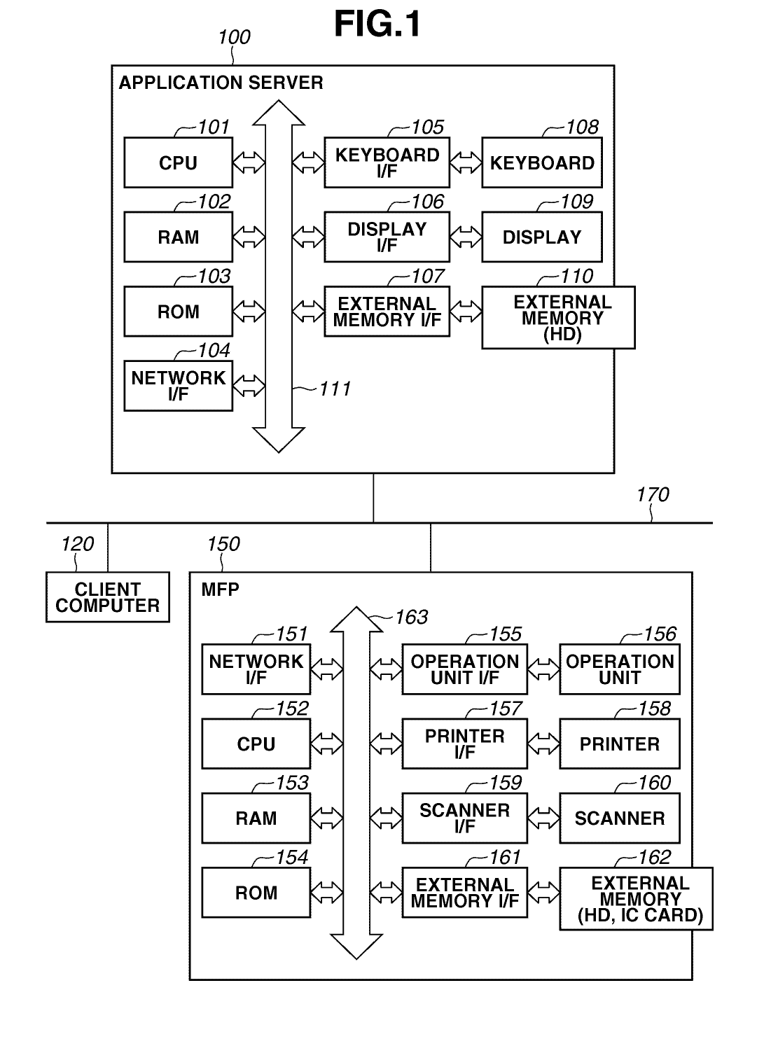

FIG. 1 is a block diagram illustrating a configuration example of a network system including an application server according to the present embodiment and a hardware configuration of each apparatus/device in the system.

The network system includes an application server 100, a client computer 120, and a MFP 150, all of which are connected to a network 170. Each of the application server 100 and the client computer 120 includes a configuration of a general-purpose personal computer. Since the hardware configuration of the client computer 120 is similar to the configuration of the application server 100, the description of the client computer 120 is not repeated. The client computer can also be a mobile terminal.

A central processing unit (CPU) 101, which is included in the application server 100, executes processing based on an application program stored in a read-only memory (ROM) 103 or an external memory 110. A program according to the present invention and which is described below is provided in such a manner that it can be acquired from a recording medium or a network. Further, the CPU 101 performs overall control of each component connected to a system bus 111. Additionally, if a user performs a point and click operation using a mouse cursor (not illustrated) on a display 109, a command is generated, and the CPU 101 opens various windows and executes data processing according to the command.

A random access memory unit (RAM) 102 functions as a main memory and a work area of the CPU 101. The ROM 103 is a read-only memory that functions as a storage area of a basic I/O program. An operating system (OS) program which is a control program of the CPU 101 is stored in the ROM 103 or the external memory 110. Further, files and various types of data, which are used when processing based on the above-described application program is performed, are stored in the ROM 103 or the external memory 110.

A network I/F 104, which is connected to the network 170, performs network communication. A keyboard I/F 105 controls input from a keyboard 108 or a pointing device (not illustrated). A display I/F 106 controls display of the display 109. An external memory I/F 107 controls access from the external memory 110 such as a hard disk (HD). The external memory 110 stores a boot program, various applications, user files, and edited files.

The application server 100 operates when the CPU 101 executes the basic I/O program and the OS stored in the ROM 103 or the external memory 110. The basic I/O program is stored in the ROM 103 and the OS is stored in the ROM 103 or the external memory 110. When the power of the computer is turned on, according to an initial program loading function of the basic I/O program, the OS stored in the ROM 103 or the external memory 110 is loaded into the RAM 102 and the operation of the OS is started. Each component of the application server is connected to the system bus 111.

Regarding the MFP 150, a network I/F 151 is connected to the network 170 and network communication is performed via the network I/F 151. A printer I/F 157 is connected to a system bus 163. A CPU 152 outputs an image signal as output information to a printer 158 based on a control program via the printer I/F 157. The control program is stored in a ROM 154 or in an external memory 162.

The CPU 152 executes communication processing with the computer via the network I/F 151. Information in the MFP 150 can be transmitted to the application server 100. Further, the CPU 152 executes processing based on an application program stored in the ROM 154 or the external memory 162.

A RAM 153 functions as a main memory and a work area of the CPU 152. The RAM 153 is configured such that its memory capacity can be increased when it is connected to an extension port (not illustrated). Further, the RAM 153 is used as an output information loading area and an environment data storage area. The RAM 153 can also be a non-volatile RAM (NVRAM).

The external memory 162 is a hard disk (HD) or the like. A control program of the CPU 152, font data which is used when the above-described output information is generated, and information used by the MFP 150 are stored in the ROM 154 or the external memory 162.

An operation unit I/F 155 is an interface of an operation unit 156. Image data to be displayed on the operation unit 156 is output to the operation unit 156. Further, the operation unit I/F 155 receives information input by the user via the operation unit 156. The operation unit 156 corresponds to an operation panel on which switches and a light-emitting diode (LED) display are arranged. The printer I/F 157 outputs an image signal as output information to the printer 158 (printer engine). A scanner I/F 159 receives an image signal as input information from a scanner 160 (scanner engine).

An external memory I/F (memory controller) 161 controls access from the external memory 162. The external memory 162 is, as described above, a hard disk (HD) or an IC card. Further, in addition to an external memory that stores integrated fonts, a plurality of additional external memories that store an option font card, a program used interpreting a printer control language of a different language system can be connected to the external memory I/F. Further, a NVRAM (not illustrated) can be included in the MFP 150. Printer mode setting information output from the operation unit 156 can be stored in the NVRAM. The system bus 163 connects each component.

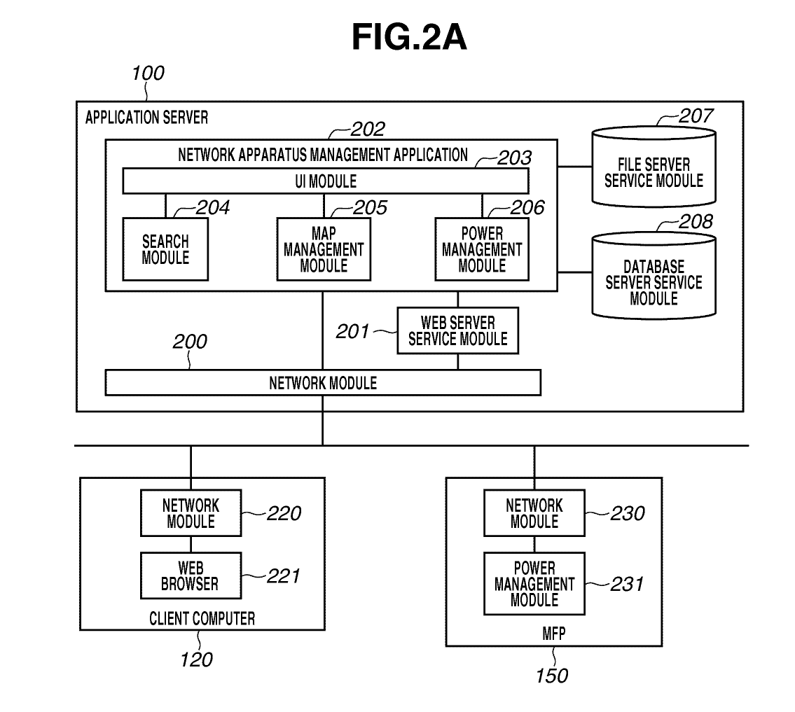

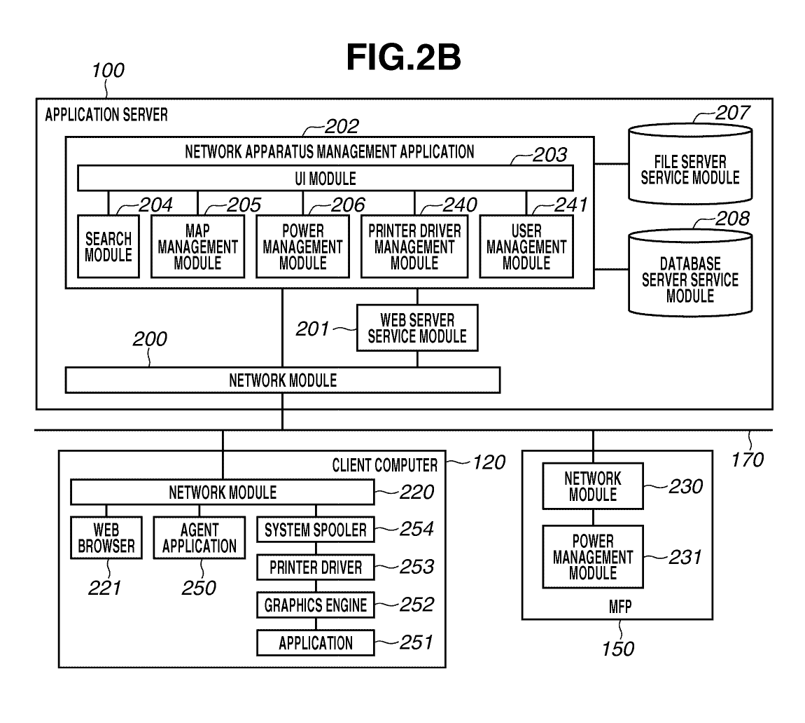

FIG. 2A is a block diagram illustrating a software configuration of the network system including the application server according to the present embodiment.

Regarding the application server 100, a management application 202 that manages a network device and each module exist as files stored in the external memory 110. These are program modules which are loaded into the RAM 102 and executed by the OS or a module using the program modules when an operation is executed. Further, the management application 202 can be added to a CD-ROM (not illustrated) of the external memory 110 or a HD of the external memory 110 via the network 170.

A network module 200 performs network communication with the client computer 120 or the MFP 150 according to an arbitrary communication protocol. A web server service module 201 receives a Hypertext Transfer Protocol (HTTP) request from a web browser 221 of the client computer 120. When the web server service module 201 receives a HTTP request, it sends out a HTTP response that corresponds to the request. The web server service module 201 transmits, for example, web page data stored in the external memory 110 as the HTTP response. Further, the web server service module 201 can request a UI module 203 of the management application 202 to generate the HTTP response.

The management application 202 is an application that manages the client computer 120 and the MFP 150 which are connected to the application server 100 via the network 170. The management application 202 is, for example, implemented as a program that executes processing in response to a request for a web page provided by the web server service module 201.

Together with the web server service module 201, as described above, the management application 202 realizes the web application that manages the client computer 120 and the MFP 150.

The UI module 203 included in the management application 202 generates a HTTP response according to a request sent from the web server service module 201. Further, the UI module 203 receives information input by the user and sent from the web browser 221 of the client computer 120, and invokes each module as needed.

Various modules are invoked by the UI module 203. They are, for example, a search module 204, a map management module 205, and a power management module 206. Other modules are also invoked by the UI module 203.

The search module 204 searches the client computer 120 and the MFP 150 which are connected to the application server 100 via the network 170 by using an arbitrary communication protocol. The communication protocol used by the search module 204 is a protocol such as Simple Network Management Protocol (SNMP) or Service Location Protocol (SLP). Further, communication protocols such as Simple Services Discovery Protocol (SSDP) and Web Services Dynamic Discovery (WS-Discovery) can also be used. When the search module 204 makes a search in the MFP 150, it acquires device information from the MFP 150. The device information is stored in a network device management table 300 in a database server service module 208.

A map management module 205 manages map information indicating where the application server 100, the client computer 120, and the MFP 150 are located. The map information includes background image information which is information of the layout as well as coordinates information of the location of the application server 100, the client computer 120, and the MFP 150. The background image information is stored as a file in a file server service module 207 or stored in a database 208 described below as image data.

The power management module 206 turns on/off the power of the MFP 150 or restarts the MFP 150. When the power management module 206 receives a power control instruction, it transmits a power control command to the MFP 150 via the network 170 according to an arbitrary communication protocol. An existing management protocol such as SNMP can be used as the communication protocol for the power control, but an original protocol can also be used. If the power management module 206 uses SNMP as the communication protocol for the power control, the power management module 206 will be a SNMP manager.

A file server 207, which is a file server service module, manages the files. When a request is transmitted from a module, the file server 207 stores or outputs a file according to the request. If the file server 207 can be accessed from the management application 202, the file server 207 can be included in an apparatus other than the application server 100. Protocols such as File Transfer Protocol (FTP) and Web-based Distributed Authoring and Versioning (WebDAV) can be used for the transmission/reception of a file via the network 170.

The database 208, which is a database server service module, manages data. When a request is transmitted from a module, the database 208 stores or outputs data according to the request. If the database 208 can be accessed from the management application 202, the database 208 can be included in an apparatus other than the application server 100.

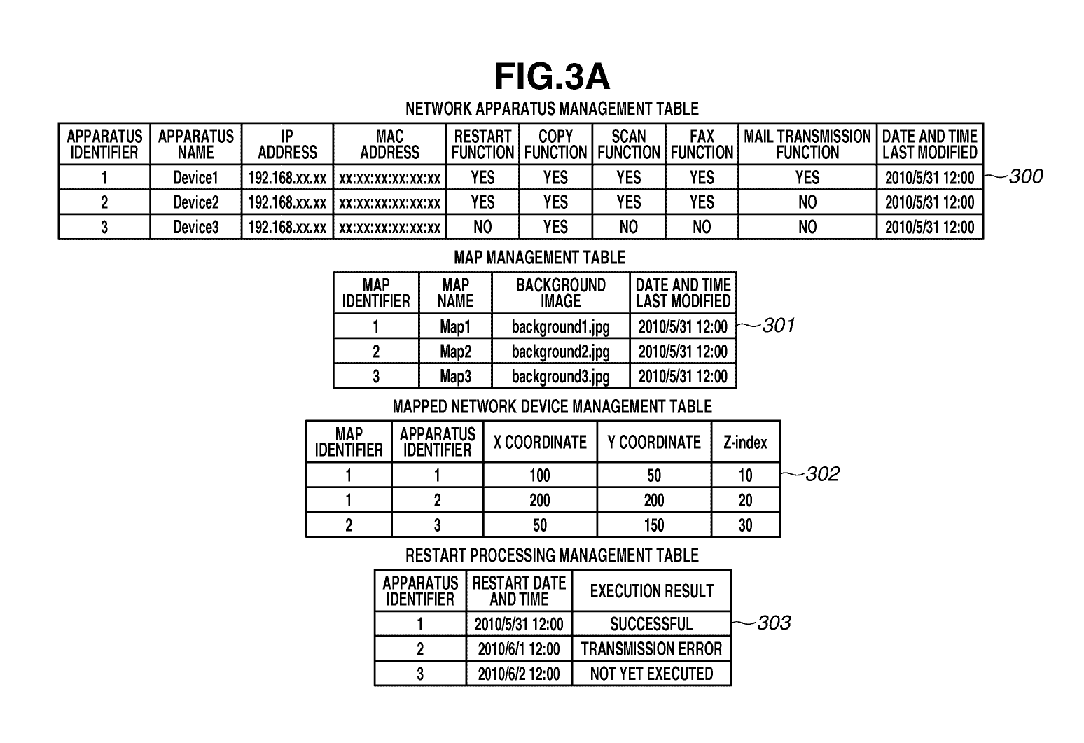

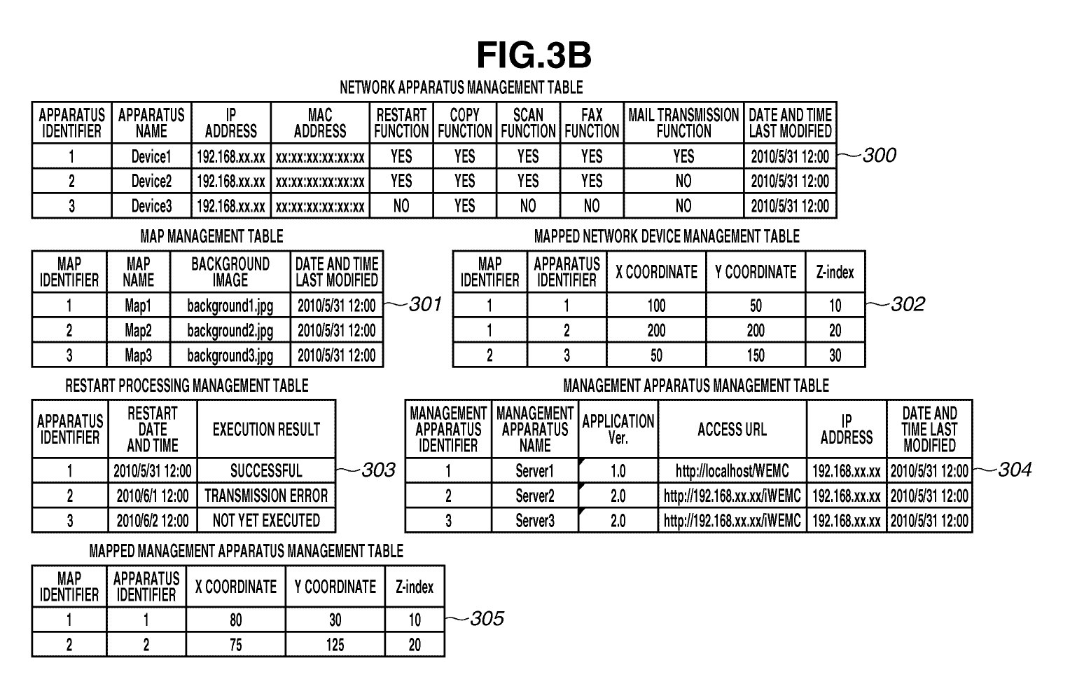

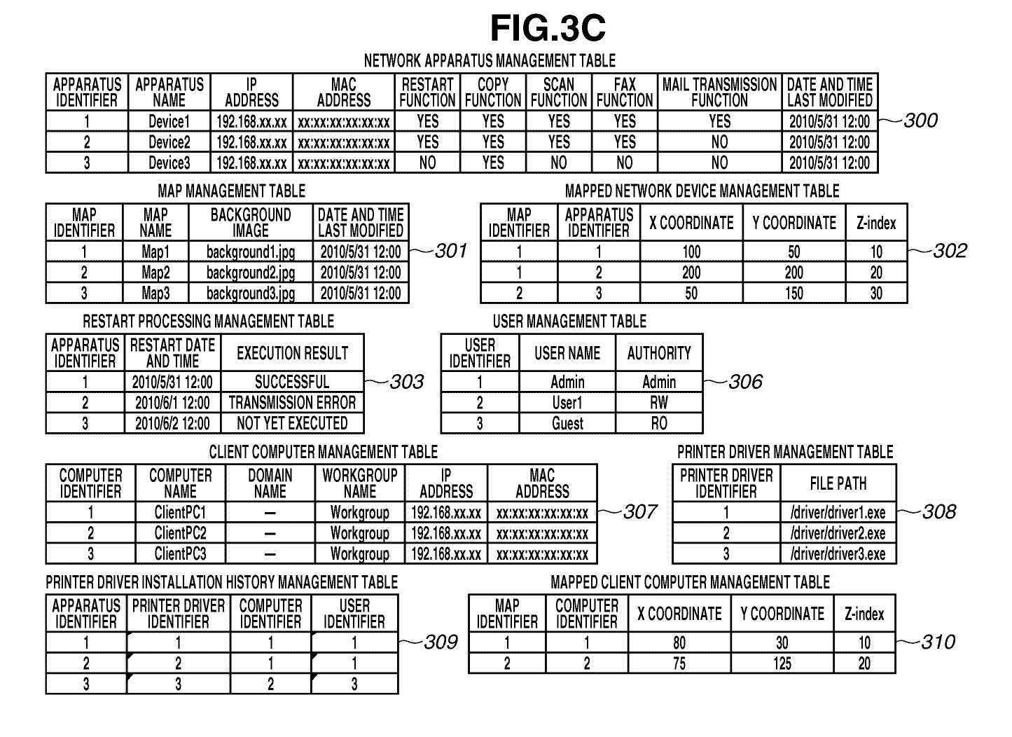

An example of a table configuration in the database 208 is illustrated in FIG. 3A. The table configuration in FIG. 3A is an example and a different table configuration can be used.

The network device management table 300 is a table that manages information of the MFP 150 managed by the management application 202. The information managed by the network device management table 300 is, for example, device identifier, model, device name, IP address, Media Access Control (MAC) address, presence/absence of scan/FAX function, and date and time last modified. The device identifier is used for uniquely identifying the MFP 150. The date and time last modified is information of the latest date and time the device information has been acquired from the MFP 150.

A map management table 301 is a table that manages information of a map managed by the management application 202. The map visualizes the location information of the application server 100, the client computer 120, and the MFP 150. The information managed by the map management table 301 is, for example, map identifier, map name, image data of the background image or file path, and the date and time last modified. The map identifier is used for uniquely identifying the map. The date and time last modified is information of the latest date and time the map information has been modified.

A mapped network device management table 302 is a table that manages information of the MFP 150 on the map. The information managed by the mapped network device management table 302 is, for example, map identifier, device identifier, and coordinates information of the MFP 150 on the map.

A restart processing management table 303 is a table that manages information necessary in restarting the MFP 150. The information managed by the restart processing management table 303 is, for example, device identifier, restart execution time, and execution result.

Referring back again to FIG. 2A, software configuration of the client computer 120 will be described. Each module that configures the client computer 120 is a program module that exists as a file stored in the ROM 103 or the external memory 110. When a program is executed, each program module is loaded into the RAM 102 and executed by the OS or a module that uses the module.

A network module 220 performs network communication between the application server 100 and the MFP 150 by an arbitrary communication protocol. The web browser 221 transmits a HTTP request message via the network module 220, receives a HTTP response message, and displays the message. The client computer 120 accesses the application server 100 via the web browser 221.

Next, the software configuration of the MFP 150 will be described. Regarding the MFP 150, each module exists as a file stored in the ROM 154 or the external memory 162. Each module is loaded into the RAM 153 and then executed. A network module 230 performs network communication between the application server 100 and the client computer 120 by using an arbitrary communication protocol. A power management module 231 controls power on/off and restart of the MFP 150.

If the management application 202 of the application server 100 uses SNMP as the communication protocol for the power control, the power management module 231 of the MFP 150 will be a SNMP agent.

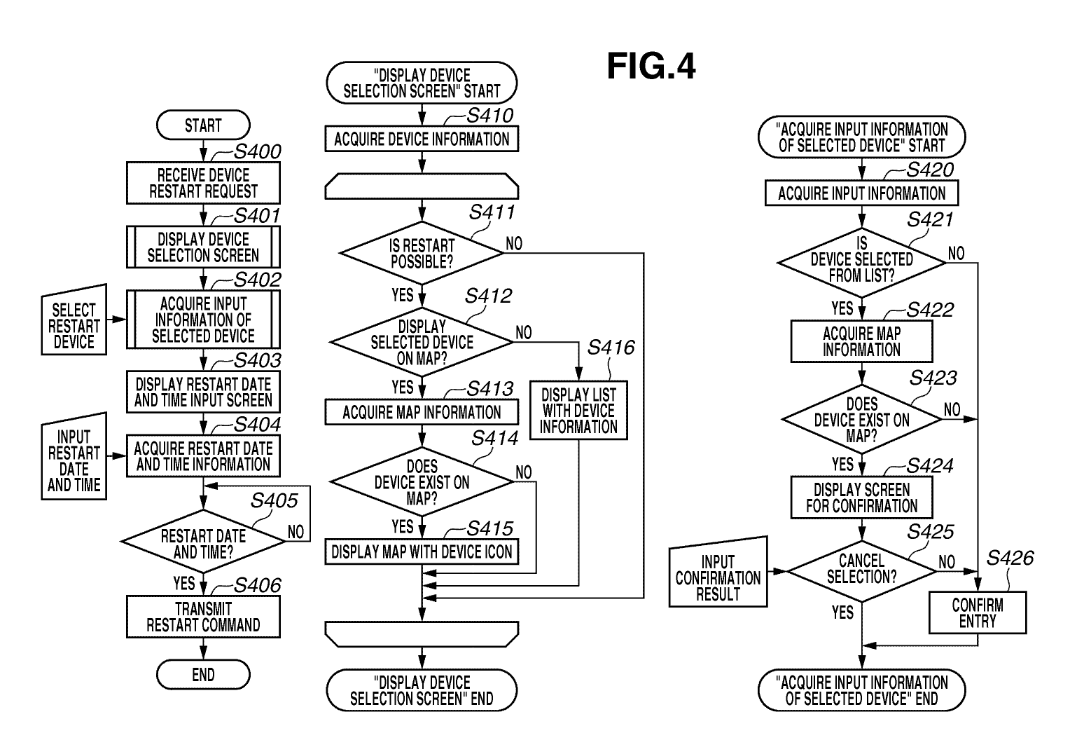

Next the operation of the application server 100 when the user restarts the MFP 150 from the application server 100 will be described with reference to FIG. 4.

In step S400, if the user sends out a restart request of the MFP 150 from the UI by using the web browser 221, the power management module 206 receives the restart request via the UI module 203.

In step S401, the power management module 206 selects the target devices which can be restarted (candidate MFP 150) and displays a selection screen of the target devices via the UI module 203. Details of the processing performed by the power management module 206 in step S401 is described with reference to steps S410 to S416 of the flowchart described below.

When the user selects a target device from the target device selection screen, the processing proceeds to step S402. In step S402, the power management module 206 acquires information of the selected target device via the UI module 203 and stores the information in the restart processing management table 303 in the database 208. The processing of the power management module 206 performed in step S402 is described with reference to steps S420 to S426 in the flowchart described below.

In step S403, the power management module 206 displays a screen used for inputting the date and time the MFP 150 is to be restarted via the UI module 203. In step S404, the power management module 206 acquires information of the execution date and time input by the user via the UI module 203 and stores the information in the restart processing management table 303 in the database 208.

In step S405, the power management module 206 determines whether the present date and time is the execution date and time of restart registered in the restart processing management table 303 of the database 208. If the present date and time is the execution date and time (YES in step S405), the processing proceeds to step S406. If the present date and time is not yet the execution date and time (NO in step S405), the processing in step S405 is repeated.

In step S406, the power management module 206 transmits a restart command to the MFP 150 and the MFP 150 is restarted. The power management module 206 stores the result of the restart in the restart processing management table 303 in the database 208.

Next, the processing of the power management module 206 displaying the target device selection screen used for selecting the MFP 150 to be restarted from the candidate devices performed in step S401 will be described in detail according to steps S410 to S416 of the flowchart described below.

In step S410, the power management module 206 acquires device information of all the MFP 150 managed by the management application 202 from the network device management table 300 in the database 208. The processing in steps S411 to S416 will be performed for each MFP 150 whose information is acquired in step S410.

In step S411, the power management module 206 selects one MFP 150 and determines whether the MFP 150 can be restarted based on the device information acquired in step S410. If the MFP 150 can be restarted (YES in step S411), the processing proceeds to step S412. If the MFP 150 cannot be restarted (NO in step S411), the processing of the selected MFP 150 ends, and the processing of the next MFP 150 is started.

In step S412, the power management module 206 determines whether the selected target device is to be displayed on the map. The power management module 206 can make the determination based on, for example, information input by the user or a registration state of the map with respect to the management application 202. If it is determined that the device is to be included (YES in step S412), the processing proceeds to step S413. If it is determined that the device is not to be included (NO in step S412), the processing proceeds to step S416.

In step S413, the power management module 206 acquires map information of the map management table 301 and the mapped network device management table 302 in the database 208 via the map management module 205.

In step S414, the power management module 206 determines whether the MFP 150 exists on the map based on the map information acquired in step S413. If the MFP 150 exists on the map (YES in step S414), the processing proceeds to step S415. If the MFP 150 does not exist on the map (NO in step S414), the processing of the selected MFP 150 ends. Then, the power management module 206 displays information of the next MFP 150.

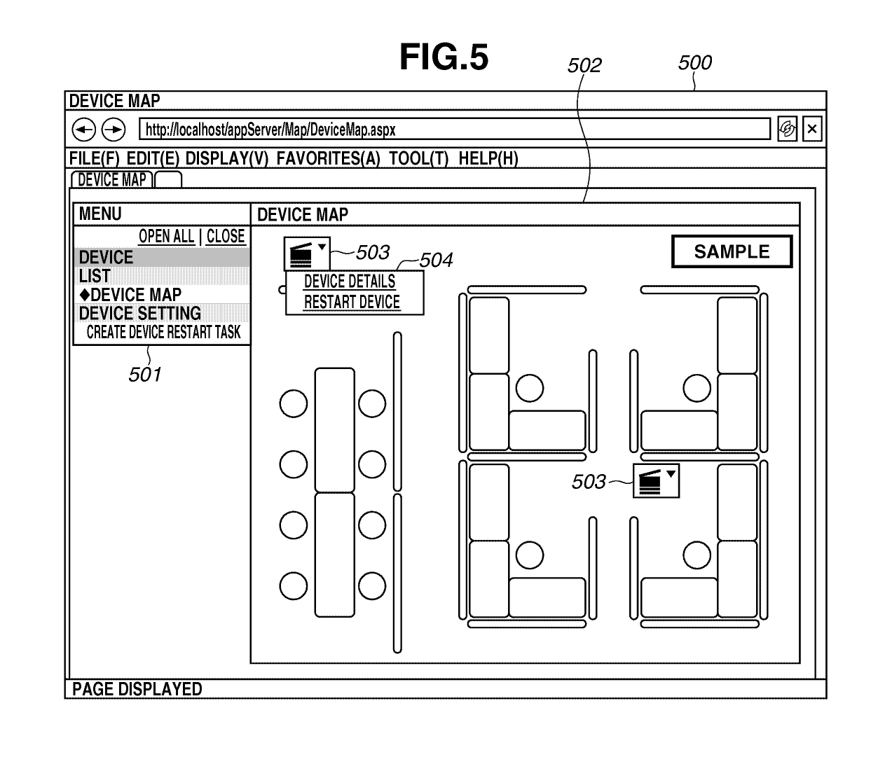

In step S415, the power management module 206 displays an icon corresponding to the MFP 150 (see FIG. 5).

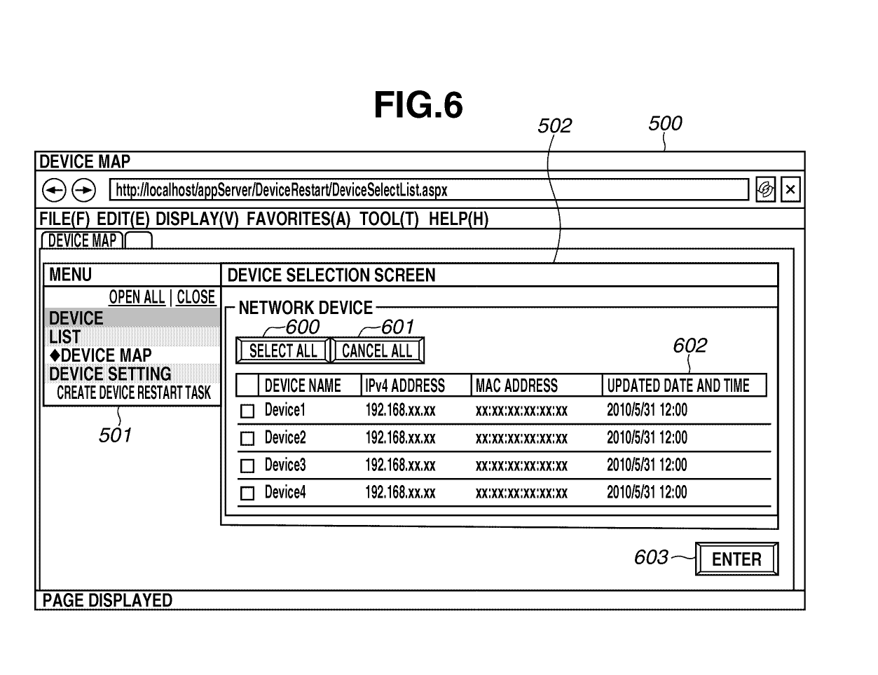

In step S416, the power management module 206 displays a list including information of the MFP 150 (see FIG. 6)

When the processing in step S415 or S416 is completed, processing of the selected MFP 150 ends, and the processing of the next MFP 150 is started. When processing in steps S411 to S416 are completed with respect to all the MFP 150 managed by the management application 202, the processing of the power management module 206 in step S401 ends.

FIG. 5 illustrates a web browser screen 500. The web browser screen 500 is displayed if the client computer 120 accesses the application server 100 via the web browser 221.

A menu area 501 is where a menu from which the user selects a network device administrative work is displayed. The menu is displayed in hierarchical structure for each category. A content area 502 is where the content corresponding to an item selected by the user from the menu area 501 is displayed. If the user selects an item from the menu displayed in the menu area 501 from the web browser 221 of the client computer 120, the display of the content area 502 is changed according to processing of the UI module 203 of the application server 100.

In FIG. 5, a device map menu is selected from the menu area 501 and the content of the device map is displayed in the content area 502. A network device icon 503 represents the MFP 150 and indicates where the MFP 150 is located. A network device icon menu 504 is a pop-up menu of a context which is displayed when the network device icon 503 is clicked. Network device administrative work which can be executed for the MFP 150 corresponding to the network device icon 503 will be displayed in the menu of the network device icon menu 504.

Although the illustration in FIG. 5 includes a menu of the details of the device and a menu used for restarting the device, other menus can also be displayed.

If the user selects the device map menu from the menu area 501, the power management module 206 executes the processing in steps S410 to S416, and a background image of the map and the network device icon 503 are displayed in the content area 502 via the UI module 203. If the user selects the device restart menu from the network device icon menu 504, which is displayed in a pop-up window when the network device icon 503 is clicked, the power management module 206 executes the processing in step S402.

FIG. 6 illustrates another example of the web browser screen 500. Since the screen in FIG. 6 is similar to the screen described above with respect to FIG. 5, only the different portions will be described. In FIG. 6, device restart task creation is selected by the user from the menu area 501 and a list of the MFP 150 is displayed in the content area 502. The user can select the MFP 150 as a restart target by checking the check box.

If the user selects a select all button 600, the state of all the MFP 150 displayed in a list area 602 described below is changed to a selected state. If the user selects a cancel button 601, the selected state of all the MFP 150 displayed in the list area 602 described below is cancelled. The list area 602 is used for the selection of a network device. The list area 602 includes a check box which is used when the user selects a restart target (MFP 150) and columns each of which displays the information of the MFP 150.

Although the screen in FIG. 6 includes device name, IP address, MAC address, and date last modified as information of the MFP 150, other information can also be displayed.

If the user selects the menu of the device restart task creation from the menu area 501, the power management module 206 executes the processing in steps S410 to S416 and displays a list for network device selection in the content area 502 via the UI module 203. Further, if the user clicks an enter button 603, the MFP 150 which has been selected from the list area 602 is determined as the restart target and the power management module 206 executes the processing in step S402.

Next, processing of the power management module 206 when it acquires the information of the target device selected in step S402 will be described in detail with reference to steps S420 to S426 in the flowchart.

In step S420, the power management module 206 acquires information of the MFP 150 which is a restart target input by the user. In step S421, the power management module 206 determines whether the user has selected the target device from the list. If the target device has been selected from the list (YES in step S421), the processing proceeds to step S422. If the target device has not been selected from the list (NO in step S421), the processing proceeds to step S426.

In step S422, the power management module 206 acquires the map information from the map management table 301 and the mapped network device management table 302 in the database 208 via the map management module 205.

In step S423, the power management module 206 determines whether the MFP 150 as a restart target exists on the map based on the map information acquired in step S422. If the MFP 150 as a restart target exists on the map (YES in step S423), the processing proceeds to step S424. If the MFP 150 as a restart target does not exist on the map (NO in step S423), the processing proceeds to step S426.

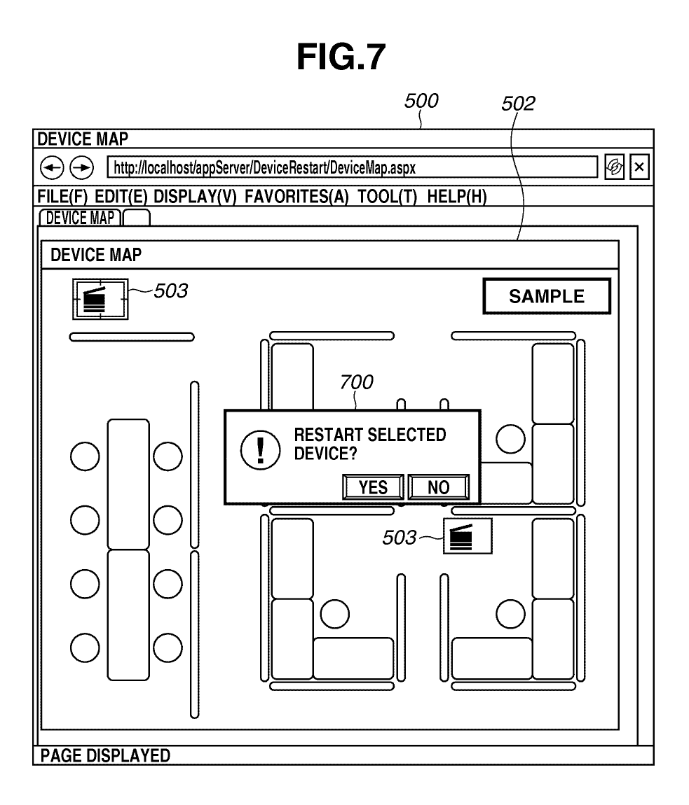

In step S424, the power management module 206 displays an icon corresponding to the MFP 150 on the map via the UI module 203 and displays a message prompting the user to confirm the target device to be restarted (see FIG. 7).

In step S425, the power management module 206 determines whether the user has cancelled the selection of the target device. If the user has cancelled the selection of the target device (YES in step S425), the information of the target device which has been selected by the user is abandoned, and the processing ends. On the other hand, if the user has not cancelled the selection of the target device (NO in step S425), the processing proceeds to step S426.

In step S426, the power management module 206 determines the information input by the user as the information of the device to be restarted, and registers the information in the restart processing management table 303 in the database 208. Then the processing ends.

FIG. 7 illustrates the web browser screen displaying an example of a network device confirmation map used in step S424. Since the screen is similar to the screen described with reference to FIG. 5, only the different portions will be described.

A confirmation message dialog box 700 is where a message prompting the user to determine the restart target device and buttons used for the confirmation of the restart target are provided. In FIG. 7, out of a plurality of the network device icons 503, the frame of the icon of the restart target device (the MFP 150) is highlighted. If a plurality of MFP 150 is selected as the restart target, a different highlighting method can be used in notifying the user of the target devices. For example, a check box can be provided for each network device icon 503.

The power management module 206 determines whether the user has cancelled the selection of the target device based on the information input by the user clicking the button on the confirmation message display dialog in step S425.

According to the above-described processing, based on restart reasons and management reasons and management status of the MFP 150, the user can confirm the location of the device by a map as needed before restarting the MFP 150 from the application server 100.

According to the first exemplary embodiment, whether a map or a list is to be used for the display of the MFP 150 as the restart candidate by the application server 100 is determined according to the item selected by the user from the menu area 501 on the UI. According to the second exemplary embodiment, the application server 100 automatically determines whether a map or a list is to be used for the display of the MFP 150 as the restart candidate according to the location of the MFP 150, in other words, whether its location is in the vicinity of the application server 100.

Since the system configuration, the hardware configuration, and the software configuration of the network system including the application server 100 of the present embodiment are similar to those illustrated in FIGS. 1 and 2A of the first exemplary embodiment, their descriptions are not repeated.

FIG. 3B illustrates an example of a configuration of a table in the database 208 of the application server having a software configuration illustrated in FIG. 2A. The table configuration in FIG. 3B is only an example and a different table configuration can also be used. Further, descriptions of the components are similar to those described with respect to FIG. 3A according to the first exemplary embodiment, therefore are not repeated.

A management apparatus management table 304 is a table that manages information of the servers including the application server 100 itself managed by the management application 202. The information managed by the management apparatus management table 304 is, for example, identifier and name of management apparatus, application version, access URL, IP address, and date and time last modified.

The identifier of the management apparatus uniquely identifies the application server 100. The application version indicates the version of the management application 202 installed in the application server 100. The access URL is a URL address which is used when the client computer 120 accesses the application server 100 using the web browser 221.

A mapped management apparatus management table 305 is a table that manages information of the servers including the application server 100 itself arranged on the map. The information managed by the mapped management apparatus management table 305 is, for example, map identifier, management device identifier, and coordinates information of the servers on the map.

Since the operations of the application server 100 when the user restarts the MFP 150 from the application server 100 are similar to the processing in steps S400 to S406 in FIG. 4 according to the first exemplary embodiment, their descriptions are not repeated.

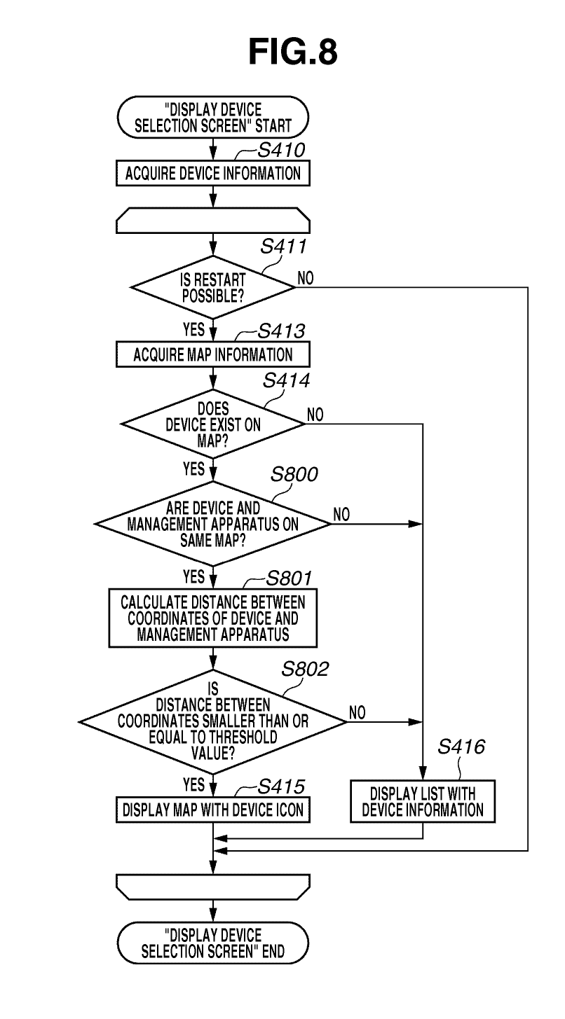

Next, the processing of the power management module 206 displaying the target device selection screen used for the selection of the MFP 150 to be restarted from the candidate devices performed in step S401 via the UI module 203 will be described in detail with reference to the flowchart in FIG. 8.

In step S410, the power management module 206 acquires device information of all the MFP 150 managed by the management application 202 from the network device management table 300 in the database 208. The processing on and after step S411 will be performed for each MFP 150 whose information has been acquired in step S410.

In step S411, the power management module 206 determines whether the MFP 150 can be restarted based on the device information acquired in step S410. If the MFP 150 can be restarted (YES in step S411), the processing proceeds to step S413. If the MFP 150 cannot be restarted (NO in step S411), the processing of the selected MFP 150 ends, and the processing of the next MFP 150 is started.

In step S413, the power management module 206 acquires the map information via the map management module 205. The acquired map information includes information stored in the map management table 301, the mapped network device management table 302, and the mapped management apparatus management table 305 in the database 208.

In step S414, the power management module 206 determines whether the MFP 150 exists on the map, based on the map information acquired in step S413. If the MFP 150 exists on the map (YES in step S414), the processing proceeds to step S800. If the MFP 150 does not exist on the map (NO in step S414), the processing proceeds to step S416.

In step S800, the power management module 206 determines whether the application server 100 managed by the power management module 206 and the MFP 150 exist on the same map based on the map information acquired in step S413. If they exist on the same map (YES in step S800), the processing proceeds to step S801. If they do not exist on the same map (NO in step S800), the processing proceeds to step S416.

In step S801, the power management module 206 calculates the distance between the coordinates of the application server 100 and the MFP 150 based on the information of their coordinates on the map.

In step S802, the power management module 206 determines whether the distance between the coordinates of the application server 100 and the MFP 150 is smaller than or equal to an arbitrary threshold value. If the distance is smaller than or equal to the threshold value (YES in step S802), the processing proceeds to step S415. If not (NO in step S802), the processing proceeds to step S416.

In step S415, the power management module 206 displays an icon corresponding to the MFP 150 on the map. On the other hand, in step S416, the power management module 206 displays a list including the information of the MFP 150. When the processing in step S415 or S416 is completed, the processing of the selected MFP 150 ends, and the processing of the next MFP 150 is started. When the processing with respect to all the MFP 150 managed by the management application 202 is completed, the processing of the power management module 206 in step S401 ends.

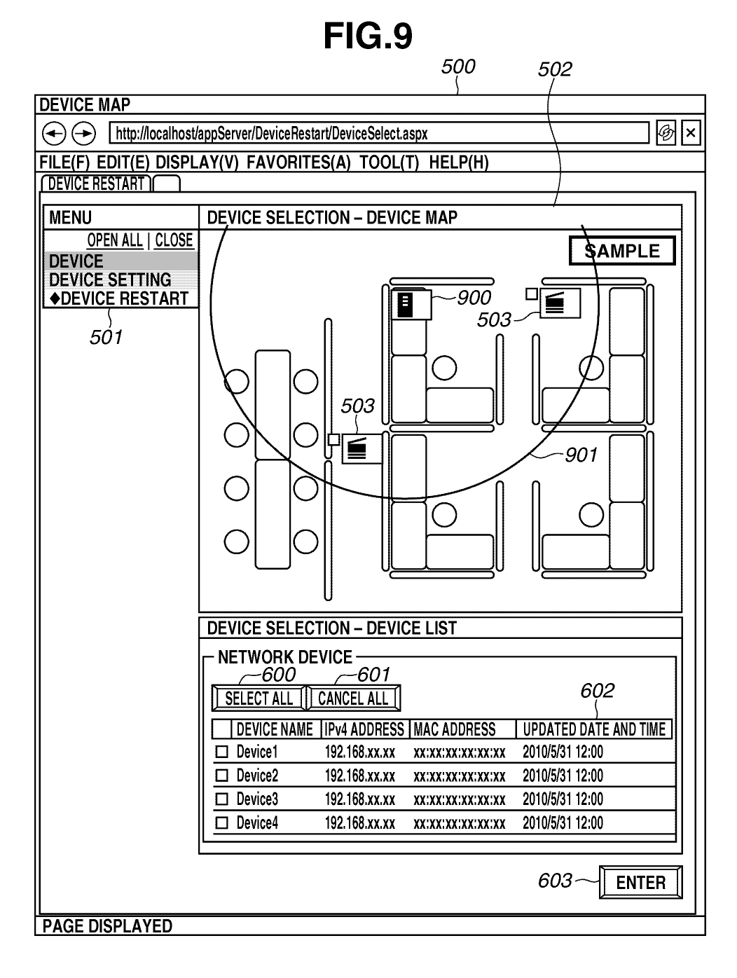

FIG. 9 illustrates an example of a screen where the map and the list of the MFP 150 displayed in steps S415 and S416 are displayed together on the same screen. In the description below, descriptions of the components similar to those described with respect to FIGS. 5 and 6 according to the first exemplary embodiment are not repeated.

The network device icon 503 in FIG. 9 is displayed together with a check box. The user selects a restart target by checking the check box. A management apparatus icon 900 represents the application server 100. A restart target network device display area 901 is an area where the MFP 150 is set up whose distance between the coordinates of itself and the application server 100 is, according to a determination by the power management module 206, smaller than or equal to the threshold value in step S802.

On this screen, only the network device icon 503 in the restart target network device display area 901 is displayed. The network device icon 503 located outside of the restart target network device display area 901 can also be displayed in such a manner that it cannot be selected by a check box.

The user selects a restart target by selecting the network device icon 503 of the target or by checking the check box of the target from the list of the MFP 150 displayed in the list area 602. If the user clicks the enter button 603, the selected MFP 150 is defined as a restart target, and the power management module 206 executes the processing in step S402.

According to the above-described processing, before the MFP 150 is restarted by the application server 100, the user can obtain information of the location of the MFP 150 arranged in the vicinity of the application server 100, by a map.

According to the second exemplary embodiment, whether a map or a list is to be used for the display of the MFP 150 as the restart candidate by the application server 100 is determined according to whether the MFP 150 is located in the vicinity of the application server 100. According to a third exemplary embodiment, whether a map or a list is to be used is determined according to access authority of a login user and a distance between the MFP 150 and the client computer 120 in which a device driver is installed.

Since the system configuration and the hardware configuration of the network system including the application server 100 of the present embodiment are similar to those of the first exemplary embodiment illustrated in FIG. 1, their descriptions are not repeated.

FIG. 2B is a block diagram illustrating a software configuration of the network system including the application server according to the present embodiment. Descriptions of the components similar to those described with respect to FIG. 2A according to the first exemplary embodiment are not repeated.

Regarding the application server 100 as a software configuration, a printer driver management module 240 manages a printer driver 253 of the MFP 150. Although the printer driver 253 that controls the print function of the MFP 150 is used as an example of a device driver in the description below, the present embodiment can be also realized by a device driver such as a scanner driver.

An installer file of the printer driver 253 is stored in the file server 207. The printer driver management module 240 communicates with an agent application 250 which operates on the client computer 120 as described below and installs the printer driver 253 in the client computer 120.

The printer driver management module 240 stores the installation history of the printer driver 253 in a history management table 309 in the database 208. A user management module 241 manages information of the login user that can use the management application 202. Further, the user management module 241 manages information of the user currently logging in to the management application 202.

Next, the software configuration of the client computer 120 will be described. The agent application 250 performs bidirectional communication with the application server 100 via the network 170 and installs the printer driver 253 in the client computer 120. An application 251 is used for printing a document. Document information is transmitted by the application 251 to a graphic engine 252.

The graphic engine 252 performs screen rendering and transmits the obtained information to the printer driver 253 as print data. Although the function of the graphic engine 252 is generally included in the OS of the client computer 120, the function can be separately included in an application.

The printer driver 253 converts the received print data and print setting into a print command (print job) in Page Description Language (PDL), and transmits the print command to a system spooler 254. The system spooler 254 sequentially transmits the print job to the MFP 150 via the network module 220.

Since the software configuration of the MFP 150 is similar to the configuration described with reference to FIG. 2A according to the first exemplary embodiment, the description is not repeated.

An example of a table configuration in the database 208 regarding the software configuration in FIG. 2B is illustrated in FIG. 3C. The table configuration in FIG. 3C is only an example and a different table configuration can also be used. Further, descriptions of the components similar to those described with respect to FIG. 3A according to the first exemplary embodiment are not repeated.

A user management table 306 is a table that manages information of the login user that uses the management application 202. Information managed by the user management table 306 is, for example, user identifier, user name, and access authority information. The user identifier is information used for uniquely identifying the user. The access authority information is information of access authority in using the management application 202.

A client computer management table 307 is a table that manages information of the client computer 120 that manages the management application 202. The information managed by the client computer management table 307 is, for example, client computer identifier, computer name, domain/work group name, IP address, and MAC address. The client computer identifier uniquely identifies the client computer 120.

A printer driver management table 308 is a table that manages information of the printer driver 253 that the management application 202 manages. The information managed by the printer driver management table 308 is, for example, printer driver identifier and file path of where the printer driver is installed. The printer driver identifier uniquely identifies the printer driver 253. The file path of where the printer driver is installed is file path information of where the installer file of the printer driver 253 is stored in the file server 207.

A history management table 309 is a table of the printer driver installation history of the printer driver 253 managed by the printer driver management module 240 in the client computer 120. The information managed by the history management table 309 is, for example, device identifier, printer driver identifier, client computer identifier, and user identifier. According to the above-described information, information of printer driver 253 installed for MFP 150 regarding client computer 120 of each user.

A mapped client computer management table 310 is a table that manages the information of the client computer 120 on the map. The information managed by the mapped client computer management table 310 is, for example, map identifier, client computer identifier, and coordinates information of the client computer 120 on the map.

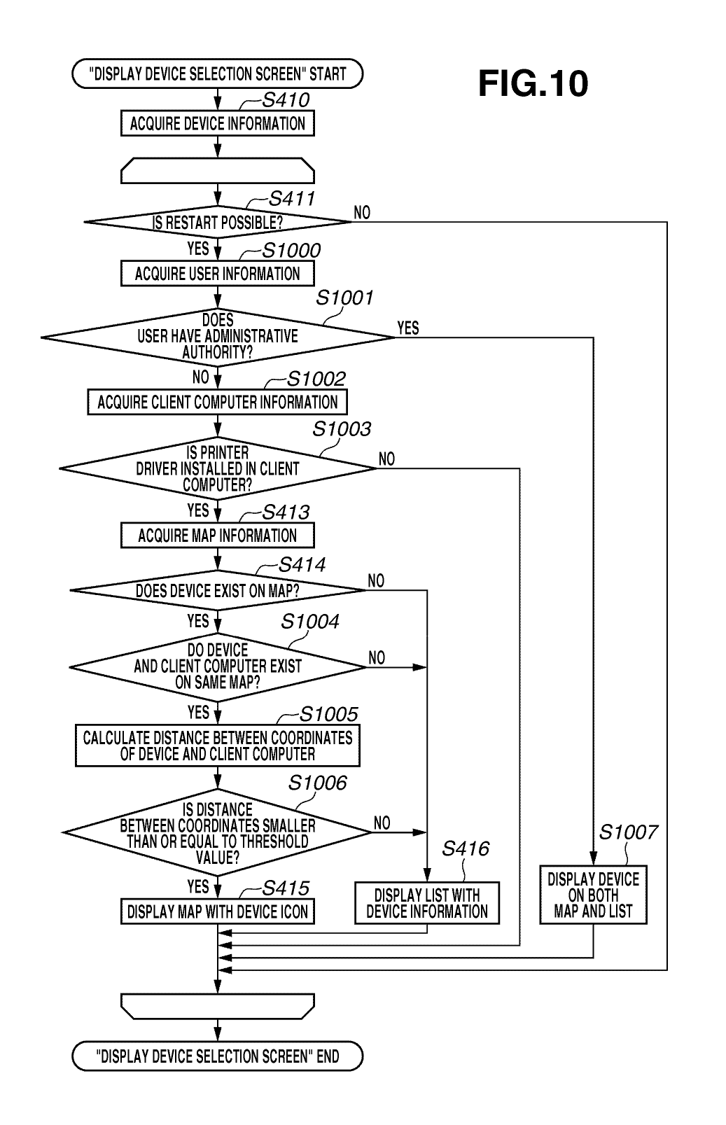

Since the operations of the application server 100 when the user restarts the MFP 150 from the application server 100 are similar to the processing in steps S400 to S406 in FIG. 4 according to the first exemplary embodiment, their descriptions are not repeated. Next, the processing of the power management module 206 displaying the target device selection screen used for selecting the MFP 150 to be restarted from the candidate devices in step S401 via the UI module 203 will be described in detail with reference to the flowchart in FIG. 10.

In step S410, the power management module 206 acquires device information of all the MFP 150 managed by the management application 202 from the network device management table 300 in the database 208. The processing in and after step S411 will be performed for each MFP 150 whose information has been acquired in step S410.

In step S411, the power management module 206 determines whether the MFP 150 can be restarted based on the device information acquired in step S410. If the MFP 150 can be restarted (YES in step S411), the processing proceeds to step S1000. If the MFP 150 cannot be restarted (NO in step S411), the processing of the selected MFP 150 ends, and the processing of the next MFP 150 is started.

In step S1000, the power management module 206 acquires user information of the user currently logging in to the management application 202 via the user management module 241.

In step S1001, the power management module 206 determines whether the login user has the administrator (Admin) authority based on the user information of the login user acquired in step S1000. If the login user does not have the administrator authority (NO in step S1001), the processing proceeds to step S1002. If the login user has the administrator authority (YES in step S1001), the processing proceeds to step S1007.

If the login user has the administrator authority, according to the processing in step S1007, all the managed MFP 150 are displayed by both the map and the list as restart target candidates. On the other hand, if the login user does not have the administrator authority, according to the processing in step S1002 and later, the user displays only the MFP 150 having the printer driver 253 installed as the restart target candidate by a map or a list.

In step S1002, the power management module 206 acquires information about the client computer 120. The client computer information includes information of the client computer management table 307 and the history management table 309 in the database 208.

In step S1003, based on the client computer information acquired in step S1002, the power management module 206 determines whether the printer driver 253 is already installed in the client computer 120. If the printer driver is already installed in the client computer (YES in step S1003), the processing proceeds to step S413. If the printer driver is not yet installed in the client computer (NO in step S1003), the processing of the selected MFP 150 ends. Then, the processing proceeds to the processing of the next MFP 150.

In step S413, the power management module 206 acquires the map information via the map management module 205. The acquired information is, for example, the map management table 301, the mapped network device management table 302, the mapped client computer management table 310, and information which is stored in the database 208.

In step S414, the power management module 206 determines whether the MFP 150 exists on the map based on the map information acquired in step S413. If the MFP 150 exists on the map (YES in step S414), the processing proceeds to step S1004. If the MFP 150 does not exist on the map (NO in step S414), the processing proceeds to step S416.

In step S1004, the power management module 206 determines whether the client computer 120 in which the printer driver 253 for the MFP 150 is installed, exists on the same map as the MFP 150. When the power management module 206 makes the determination in step S1004, the client computer information acquired in step S1002 and the map information acquired instep S413 is used. If the client computer 120 and the MFP 150 exist on the same map (YES in step S1004), the processing proceeds to step S1005. If the client computer 120 and the MFP 150 do not exist on the same map (NO in step S1004), the processing proceeds to step S416.

In step S1005, the power management module 206 calculates the distance between the coordinates of the client computer 120 and the MFP 150 on the map based on the coordinates information of the client computer 120 and the MFP 150.

In step S1006, the power management module 206 determines whether the distance between the coordinates of the client computer 120 and the MFP 150 is smaller than or equal to an arbitrary threshold value. If the distance is smaller than or equal to the threshold value (YES in step S1006), the processing proceeds to step S415. If not (NO in step S1006), the processing proceeds to step S416.

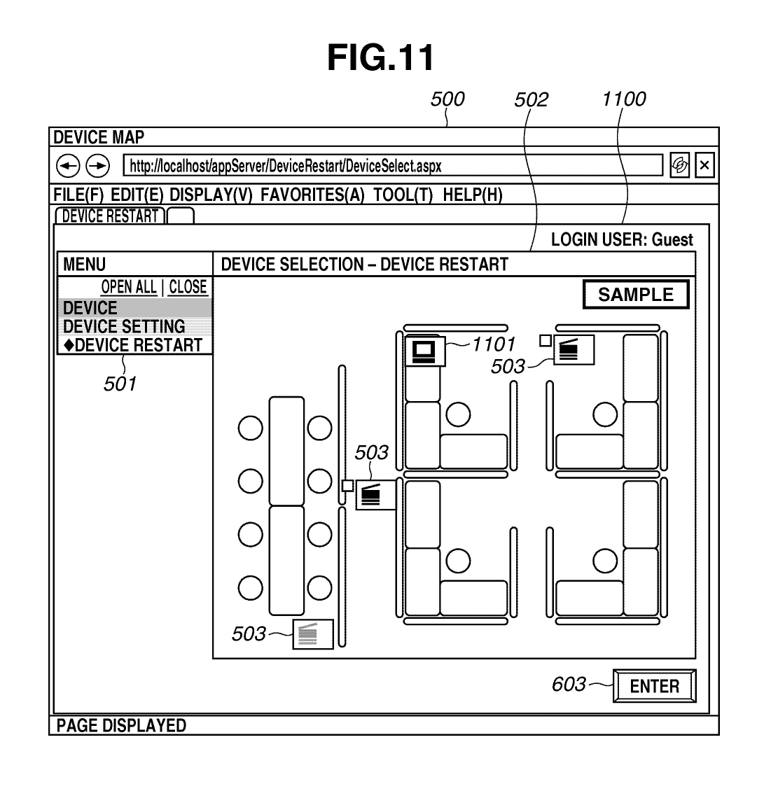

In step S415, the power management module 206 displays an icon corresponding to the MFP 150 on the map (see FIG. 11). On the other hand, in step S416, the power management module 206 displays a list including the information of the MFP 150. In step S1007, the power management module 206 displays the information of the MFP 150 by using both the map and the list.

When the processing in step S415, S416, or S1007 is completed, the processing of the selected MFP 150 ends, and the processing of the next MFP 150 is started. When the processing with respect to all the MFP 150 managed by the management application 202 is completed, the processing of the power management module 206 in step S401 ends.

FIG. 11 illustrates a screen example of the map of the MFP 150 displayed in step S415. The descriptions of the components similar to those described with respect to FIG. 5 according to the first exemplary embodiment are not repeated.

A login user display area 1100 is where the name of the user currently logging in to the management application 202 is displayed. A client computer icon 1101 represents the client computer 120 arranged on the floor.

Only the network device icon 503 within an arbitrary distance from the client computer icon 1101 is displayed on the map. The network device icon 503 at an arbitrary distance or more from the client computer icon 1101 can also be displayed in such a manner that it cannot be selected by a check box.

The user selects a restart target by selecting the check box of the network device icon 503. If the user clicks the enter button 603, the selected MFP 150 is defined as a restart target, and the power management module 206 executes the processing in step S402. Since the display of the list of the MFP 150 in step S416 is similar to the processing described with reference to FIG. 6 according to the first exemplary embodiment, the processing is not repeated.

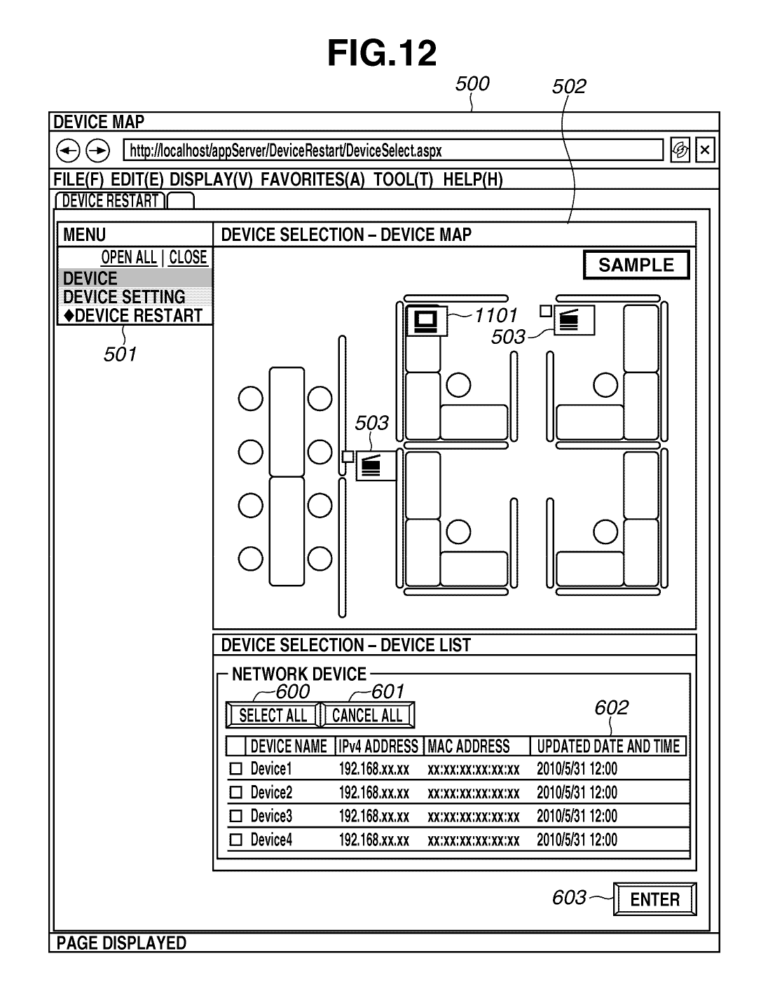

FIG. 12 illustrates an example display of the MFP 150 in step S1007. The MFP 150 is displayed on the map and also included in the list. Since FIG. 12 is similar to FIG. 9 described with reference to the second exemplary embodiment 2 and FIG. 11 described above, its description is not repeated.

According to the above-described processing, the location of the MFP 150 in the vicinity of the client computer 120 having the printer driver installed can be confirmed before it is restarted according to the access authority of the login user.

According to the first exemplary embodiment, whether a map or a list is to be used for the display of the MFP 150 being the restart candidate by the application server 100 is determined according to the item selected by the user from the menu area 501 on the UI. According to a fourth exemplary embodiment, an alert message is displayed when the map of the MFP 150 is displayed if another device (MFP 150) that has the same function and can be used as an alternate device is not in the vicinity of the MFP 150 when it is to be restarted.

Since the system configuration, the hardware configuration, and the software configuration of the network system including the application server 100 of the present embodiment are similar to those illustrated in FIGS. 1 and 2A of the first exemplary embodiment, their descriptions are not repeated. Further, since the table configuration, which is in the database 208, of the software configuration in FIG. 2A is similar to the table configuration illustrated in FIG. 3A according to the first exemplary embodiment, the description is not repeated.

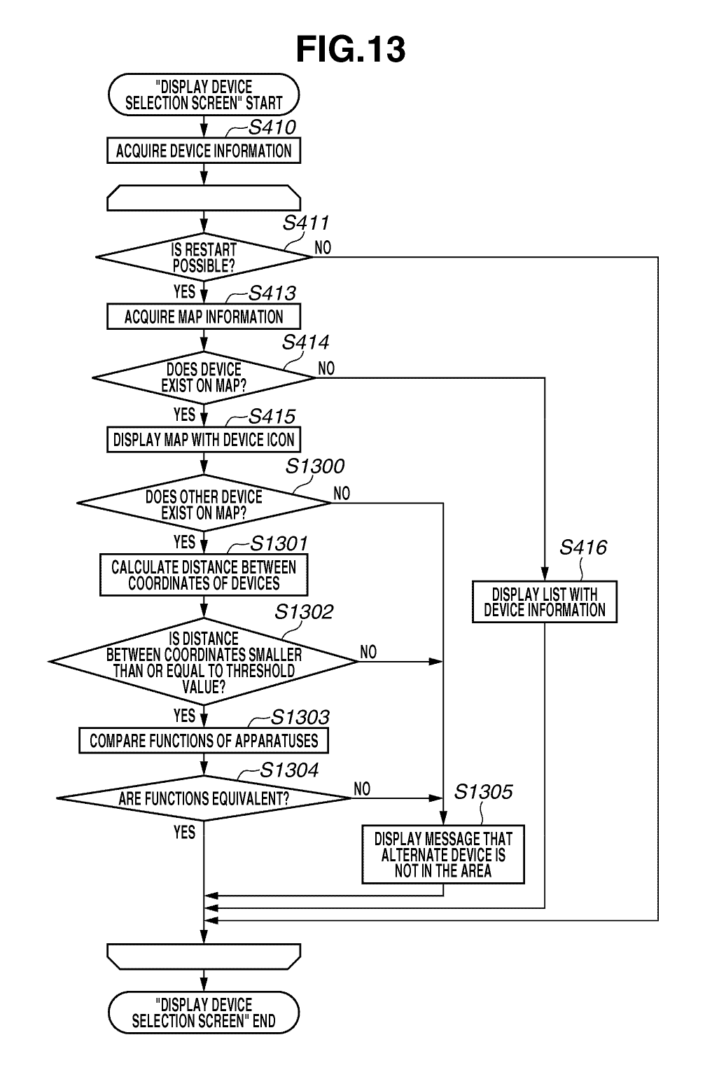

Since the operation of the application server 100 when the user restarts the MFP 150 from the application server 100 is similar to the processing in steps S400 to S406 in FIG. 4 according to the first exemplary embodiment, the description is not repeated. The processing of the power management module 206 selecting the restart candidate of the MFP 150 in step S401 and displaying the target device selection screen via the UI module 203 will be described in detail with reference to the flowchart in FIG. 13.

In step S410, the power management module 206 acquires device information of all the MFPs (MFP 150) managed by the management application 202 from the network device management table 300 in the database 208. The processing in steps S411 and later will be performed for each MFP 150 whose information has been acquired in step S410.

In step S411, the power management module 206 determines whether the MFP 150 can be restarted based on the device information acquired in step S410. If the MFP 150 can be restarted (YES in step S411), the processing proceeds to step S413. If the MFP 150 cannot be restarted (NO in step S411), the processing of the selected MFP 150 ends, and the processing of the next MFP 150 is started.

In step S413, the power management module 206 acquires map information of the map management table 301 and the mapped network device management table 302 in the database 208 via the map management module 205.

In step S414, the power management module 206 determines whether the MFP 150 exists on the map based on the map information acquired in step S413. If the MFP 150 exists on the map (YES in step S414), the processing proceeds to step S415. If the MFP 150 does not exist on the map (NO in step S414), the processing proceeds to step S416.

In step S415, the power management module 206 displays the icon corresponding to the MFP 150 on the map, and the processing proceeds to step S1300. On the other hand, in step S416, the power management module 206 displays a list including the information of the MFP 150 and the processing of the selected MFP 150 ends. Then, the processing proceeds to the next MFP 150.

In step S1300, the power management module 206 determines whether another MFP 150 exists on the map based on the map information acquired in step S413. If another MFP 150 exists on the map (YES in step S1300), the processing proceeds to step S1301. If another MFP 150 does not exist on the map (NO in step S1300), the processing proceeds to step S1305.

In step S1301, the power management module 206 calculates the distance between the coordinates of the two MFP 150 based on the information of their coordinates on the map.

In step S1302, the power management module 206 determines whether the distance between the coordinates of the two MFP 150 on the same map is smaller than or equal to an arbitrary threshold value. If the distance is smaller than or equal to the threshold value (YES in step S1302), the processing proceeds to step S1303. If not (NO in step S1302), the processing proceeds to step S1305.

In step S1303, the power management module 206 compares the function of the two MFP 150 on the same map based on the device information of the MFP 150 acquired in step S410. For example, presence/absence of a function, copy function, scan function, FAX function, or mail transmission function of a scanned document is compared.

In step S1304, the power management module 206 determines whether the two MFP 150 on the same map have an equivalent function based on the function comparison result in step S1303. If they have an equivalent function (YES in step S1304), the processing of the selected MFP 150 ends, and the processing of the next MFP 150 is started. If they do not have an equivalent function (NO in step S1304), the processing proceeds to step S1305.

In step S1305, the power management module 206 displays an alert message informing the user that there is no alternate device having the equivalent function in the vicinity. By displaying this alert message, the user is informed that an alternate device of the MFP 150 including the equivalent function does not exist in the vicinity of the MFP 150 when it is restarted.

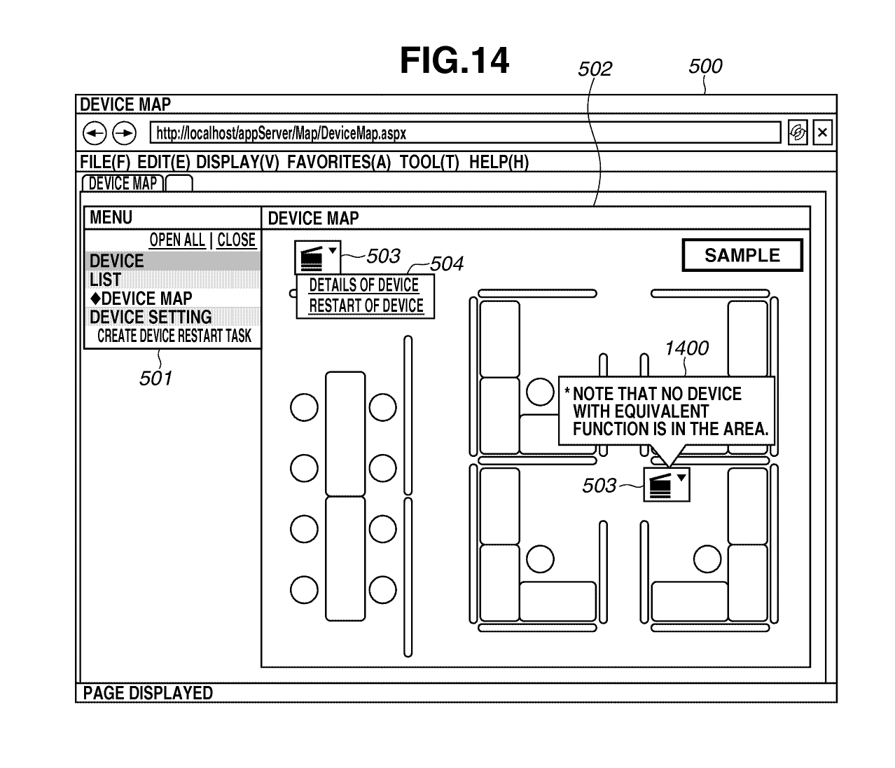

FIG. 14 illustrates an example of a screen displaying the alert message to be displayed in step S1305. Further, descriptions of the components similar to those described with respect to FIG. 5 are not repeated.

An alert message prompt box 1400 is displayed for the network device icon 503 that represents the MFP 150 which does not have an alternate device with an equivalent function in the vicinity. An alert message notifying the user that an alternate device with an equivalent function is not in the vicinity of the MFP 150 when it is restarted, is displayed in the alert message prompt box 1400.

According to the processing described above, before the MFP 150 is restarted, the user is asked to confirm its location using the map. Further, if another MFP 150 having an equivalent function and which can be used as an alternate device during the restart processing does not exist in the vicinity of the MFP 150, an alert message is displayed in advance.

### OTHER EMBODIMENTS

The present embodiment can be realized even if the application server and the client computer operate on one apparatus. Further, the management method regarding restart of a network device can be realized by combining the methods described in the above-described plurality of exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

This application claims priority from Japanese Patent Application No. 2011-021699 filed Feb. 3, 2011, which is hereby incorporated by reference herein in its entirety.

What is claimed is:

1. A management apparatus managing device information of a network device, the apparatus comprising at least a processor, functioning as:
an acquisition unit configured to acquire device information from a plurality of network devices on a network;
a first selection unit configured to display a map indicating locations of the plurality of network devices on the network and accept a selection of a network device as a restart target via the map;
a second selection unit configured to accept a selection of the network device as a restart target via a list of the plurality of network devices displayed by using the acquired device information;
an input unit configured to input a time that a request for restart of the network device selected by the first or the second selection unit is to be transmitted; and
a request unit configured to request the network device selected by the first or the second selection unit to restart at the time input via the input unit.

2. The management apparatus according to claim 1, further comprising a confirmation unit configured to display, if the network device is selected as a restart target by the second selection unit, the network device as a restart target so that the network device as a restart target can be identified on the map for confirmation before inputting the request for restart.

3. The management apparatus according to claim 1, wherein if the locations of the management apparatus and the plurality of network devices are such that the locations can be indicated on one map, the network device can be selected as a restart target by the first selection unit via the map.

4. The management apparatus according to claim 1, further comprising a warning unit configured to issue a warning when the network device is selected as a restart target by the first or the second selection unit if a network device of an equivalent function does not exist in a vicinity of the selected network device.

5. A management apparatus according to claim 1, wherein the units according to claim 1 are provided as a web service according to an input via a web browser of an external client computer.

6. The management apparatus according to claim 5, wherein an agent configured to provide information of an install-completed device driver to the management apparatus is operated on the client computer, and
wherein the first selection unit displays a map on which a network device corresponding to the install-completed device driver is indicated and selects a network device as a restart target via the map.

7. A management method of a plurality of network devices, the method comprising:
acquiring device information from a plurality of network devices on a network;
storing the acquired device information in a storage unit;
performing a first selection configured to display a map indicating locations of the plurality of network devices on the network and accept a selection of a network device as a restart target via the map;
performing a second selection configured to accept a selection of the network device as a restart target via a list of the plurality of network devices displayed by using the acquired device information;
inputting a time that a request for restart of the network device selected by the first or the second selection is to be transmitted; and
requesting the network device selected by the first or the second selection to restart at the input time.

8. A computer readable storage medium on which is stored a computer program for causing a computer to execute a method for managing a plurality of network devices, the method comprising:
acquiring device information from a plurality of network devices on a network;
storing the acquired device information in a storage unit;
performing a first selection configured to display a map indicating locations of the plurality of network devices on the network and accept a selection of a network device as a restart target via the map;
performing a second selection configured to accept a selection of the network device as a restart target via a list of the plurality of network devices displayed by using the acquired device information;
inputting a time that a request for restart of the network device selected by the first or the second selection is to be transmitted; and
requesting the network device selected by the first or the second selection to restart at the input time.
